(19) United States
(12) Patent Application Publication
(10) Pub. No.: US 2012/0073298 A1
(43) Pub. Date: Mar. 29, 2012

(54) ROTARY EXPANSION ENGINE

(76) Inventor: Neemat FREM, JOUNIEH (LB)

(21) Appl. No.: 13/241,586

(22) Filed: Sep. 23, 2011

(30) Foreign Application Priority Data
Sep. 24, 2010 (EP) 10179377.6

(51) Int. Cl. F02C 1/04

(52) U.S. Cl. 60/682

(57) ABSTRACT

A rotary engine comprising an engine block that is movable in rotation about an axle, said engine block including at least one blind cylinder mounted on a casing. Said blind cylinders are closed by respective movable pistons defining sealed chambers of variable volume inside the cylinders. Each piston is connected to a crank mechanism secured to the stub axle of the engine block. The variable-volume sealed chamber of each piston contains a fluid suitable for expanding under the effect of a rise in temperature, the engine further including heater means for raising the temperature of the fluid present in said chamber.

### BACKGROUND OF THE INVENTION

The present invention relates to the general field of rotary engines. The rotary engines that are the most widespread are ignition engines that rotate about their crank mechanisms that do not rotate. In such engines, the cylinders are arranged radially.

The main advantage of this type of engine is low weight, mainly as a result of excellent cooling because of the cylinders passing through the air, thereby enabling the weight of the cooling fins to be reduced, while presenting a moving mass that is sufficient to make it unnecessary for the engine to have a flywheel. Such engines also present a low level of vibration compared with an engine having stationary cylinders.

Nevertheless, at present, rotary engines are considered as being relatively polluting in that they present very high fuel consumption for rather low efficiency, and in that they make use of internal or external combustion. Known rotary engines also require a very large quantity of lubricating oil.

Nevertheless, there exists a need for rotary engines that generate very little pollution and that can be used in various types of environment (dwellings, vehicles, industrial installations, etc.).

### OBJECT AND SUMMARY OF THE INVENTION

An object of the present invention is to propose a novel design for a rotary engine that can be driven without requiring internal or external combustion.

In accordance with the invention, this object is achieved by the fact that the rotary engine comprises an engine block that is movable in rotation about an axle, said engine block including at least one blind cylinder mounted on a casing, said blind cylinder being closed by a movable piston defining a sealed chamber of variable volume inside the cylinder, each piston being connected to a crank mechanism secured to the stub axle of the engine block, in which engine the variable-volume sealed chamber of each piston contains a fluid suitable for expanding under the effect of a rise in temperature, the engine further including heater means for raising the temperature of the fluid present in said chamber.

Thus, the rotary engine of the invention may be driven by varying the volume of the fluid present in the sealed chamber of each cylinder. Consequently, the engine of the invention pollutes very little in that it does not make use of internal or external combustion means for driving purposes and therefore does not exhaust any combustion gas.

The engine of the invention also requires little maintenance and it runs very quietly.

In an embodiment of the invention, the heater means comprise a stationary heat source arranged on the path of each cylinder in such a manner as to heat the fluid present in each of the cylinders, in succession. In particular, the heat source may comprise radiant heater elements.

In another embodiment of the invention, the heater means comprise a susceptor formed by the wall of each cylinder of the variable-volume sealed chamber, an induction unit being arranged in a fixed position on the path of each cylinder.

According to an aspect of the invention, each cylinder includes a plurality of tubes extending from the cylinder head of each cylinder, said tubes in each plurality of tubes being in communication with the variable-volume sealed chamber containing the fluid that is suitable for expanding under the effect of a temperature rise.

These tubes serve to increase heat exchange between the fluid present inside the variable-volume chamber, and the outside.

Preferably, the tubes of each plurality of tubes are spaced apart from one another by a determined distance so as to encourage a large flow of air around the tubes.

In another aspect of the invention, each cylinder further includes a diaphragm type deformable sealing gasket comprising a body of flexible material extending between a bottom portion and a top portion, said top portion of the gasket being held against the bottom end of the piston, while the bottom portion of the gasket is held between two flanges of each cylinder.

The use of such a gasket serves to improve sealing between the variable-volume chambers and the remaining portions of the cylinder which may, under such circumstances, be connected to an oil circulation circuit.

In a particular embodiment of the invention, the engine further includes a brake device for blocking rotation of the engine block as a function of the position of each cylinder, specifically so as to enable the cylinders to remain for longer in the stationary heat source, thereby increasing the pressure of the fluid present in the variable-volume chambers. Under such circumstances, each cylinder may include a pressure sensor for measuring the pressure of the fluid present in the variable-volume chamber, the pressure measured by said sensor being transmitted to a circuit for controlling the brake device.

According to a characteristic of the invention, the fluid present in the variable-volume sealed chamber of each cylinder is selected from at least one of the following fluids having a high coefficient of thermal expansion: Freon, air, helium, hydrogen.

In an aspect of the invention, the engine further comprises a stationary cooling device arranged on the path of each cylinder in order to increase the cooling of the fluid present in each sealed chamber between two successive occasions on which the chamber is heated by the heater means.

### BRIEF DESCRIPTION OF THE DRAWINGS

Other characteristics and advantages of the invention appear from the following description of particular embodiments of the invention given as non-limiting examples and with reference to the accompanying drawings, in which:

FIG. 1 is an exploded view of an embodiment of a rotary expansion engine in accordance with the invention;

FIG. 2 is a plan view of the FIG. 1 engine once assembled;

FIG. 3 is a section view of a portion of the engine shown in FIG. 2;

FIG. 4 is a detail view showing a cylinder of the rotary engine of FIG. 1;

FIG. 5 is an exploded view of a piston and connecting rod assembly of the rotary engine of FIG. 1;

FIG. 6 is a perspective view of the FIG. 2 engine fitted with a heating enclosure and a cooling enclosure in accordance with the invention; and

FIGS. 7A to 7F show the operation of the FIG. 6 rotary expansion engine.

### DETAILED DESCRIPTION OF AN EMBODIMENT

The engine of the present invention relies on the principle of the radial rotary engine known under the name “gnome” engine, but unlike engines of that type it does not make use of internal combustion.

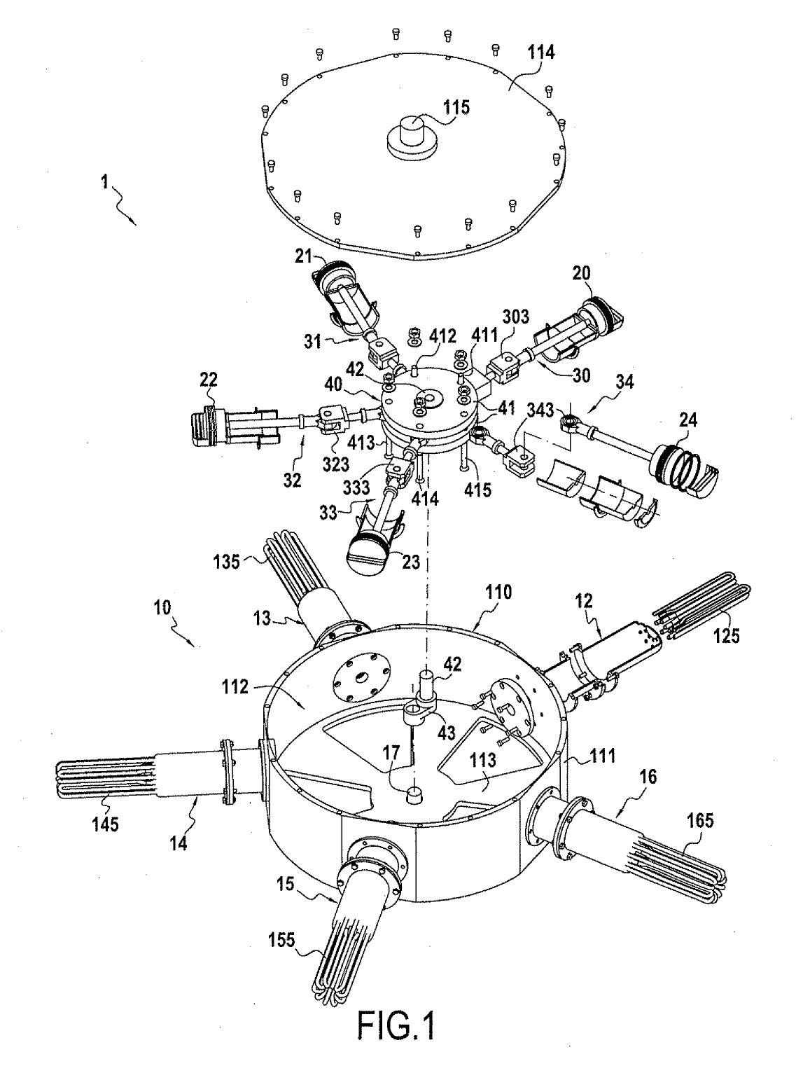

FIGS. 1 to 3 show a rotary engine 1 in accordance with an embodiment of the invention. The rotary engine comprises an engine block 10 of the radial engine type and that is movable in rotation.

The engine block 10 comprises an engine casing 110 having a cylindrical side wall 111 with five cylinders 12 to 16 mounted at the periphery thereof, the cylinders being in communication with the inside volume 112 of the engine casing 110 via openings 12a to 16a. The cylinders 12 to 16 are cylinders of the so-called “blind” type in that their ends remote from their ends fastened to the side wall 111 are closed by respective cylinder heads 121, 131, 141, 151, 161.

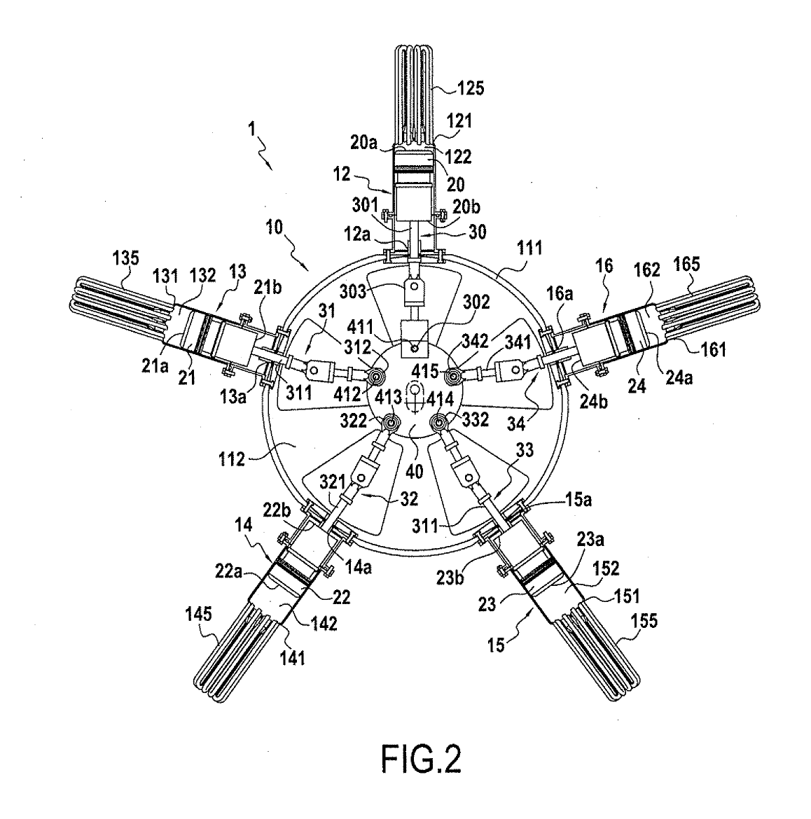

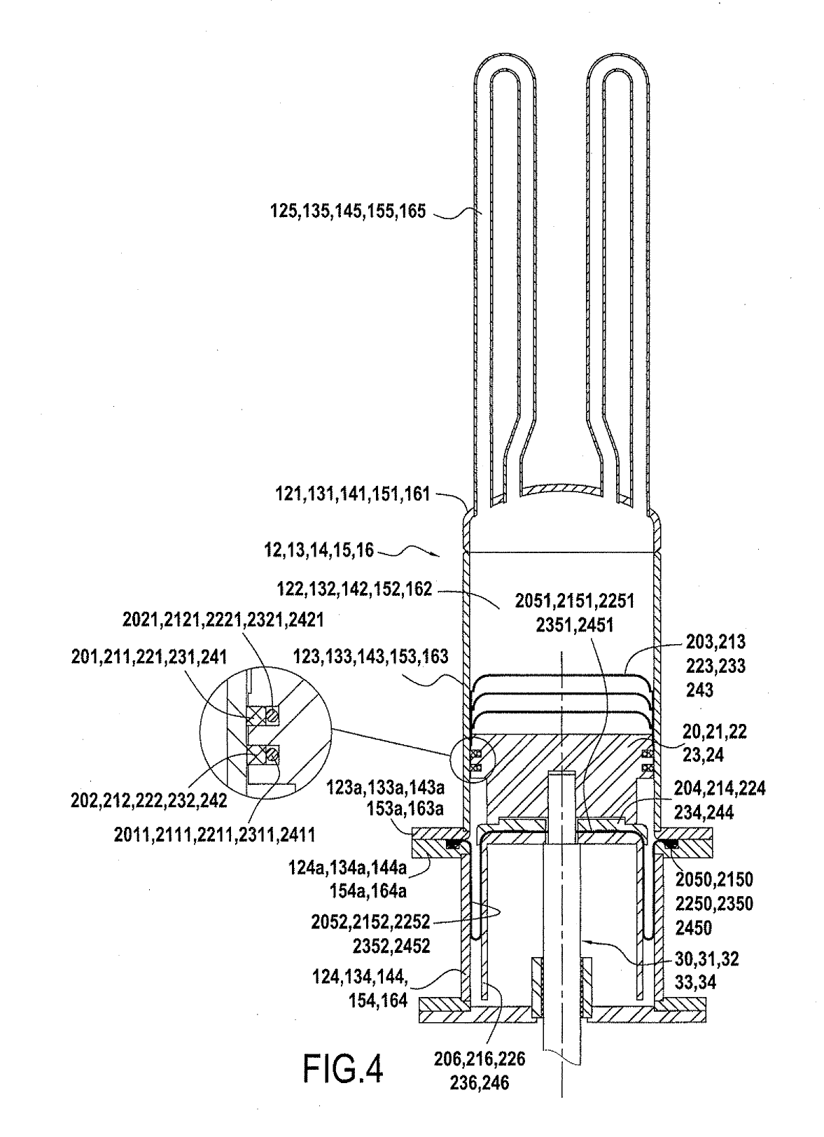

Respective pistons 20 to 24 are slidably mounted in the cylinders 12 to 16 (FIG. 2). Once mounted in the corresponding cylinder, each piston 20 to 24 co-operates with the cylinder 12 to 16 to define a sealed chamber of variable volume 122, 132, 142, 152, 162 that extends between the free end 20a to 24a of each piston 20 to 24 and each cylinder head 121, 131, 141, 151, 161 of each cylinder 12 to 16 (FIGS. 2 and 4).

As shown in FIG. 4, each cylinder 12 to 16 is made up of two portions 123/124, 133/134, 143/144, 153/154, 163/164 connected together by means of flanges 123a/124a, 133a/134a, 143a/144a, 153a/154a, 163a/164a. Each piston 12 to 16 has on its cylinder head 121, 131, 141, 151, 161 a plurality of tubes 125, 135, 145, 155, 165 communicating with the respective sealed chambers of variable volume 122, 132, 142, 152, 162. The tubes 125, 135, 145, 155, 165 are of upside-down U-shape, each forming a fluid duct for a fluid that is present both in the tubes and in the variable-volume chambers. The tubes 125, 135, 145, 155, 165 are made of a material having high thermal conductivity, such as aluminum. At least the portion 123, 133, 143, 153, 163 of each of the cylinders 12 to 16 is preferably made of the same material as the tubes 125, 135, 145, 155, 165.

Each plurality of tubes 125, 135, 145, 155, 165 serves to increase significantly the heat exchange area with the fluid present in the variable-volume chambers 122, 132, 142, 152, 162. The tubes of each plurality of tubes 125, 135, 145, 155, 165 are preferably spaced apart from one another at a distance that is determined in such a manner as to encourage a large amount of air to flow around them, as in the presently-described embodiment that is shown in particular in FIGS. 1 to 3 and 6. Thus, during rotation of the cylinders, as described below, air can flow freely around each of the tubes and receive or deliver a maximum amount of heat.

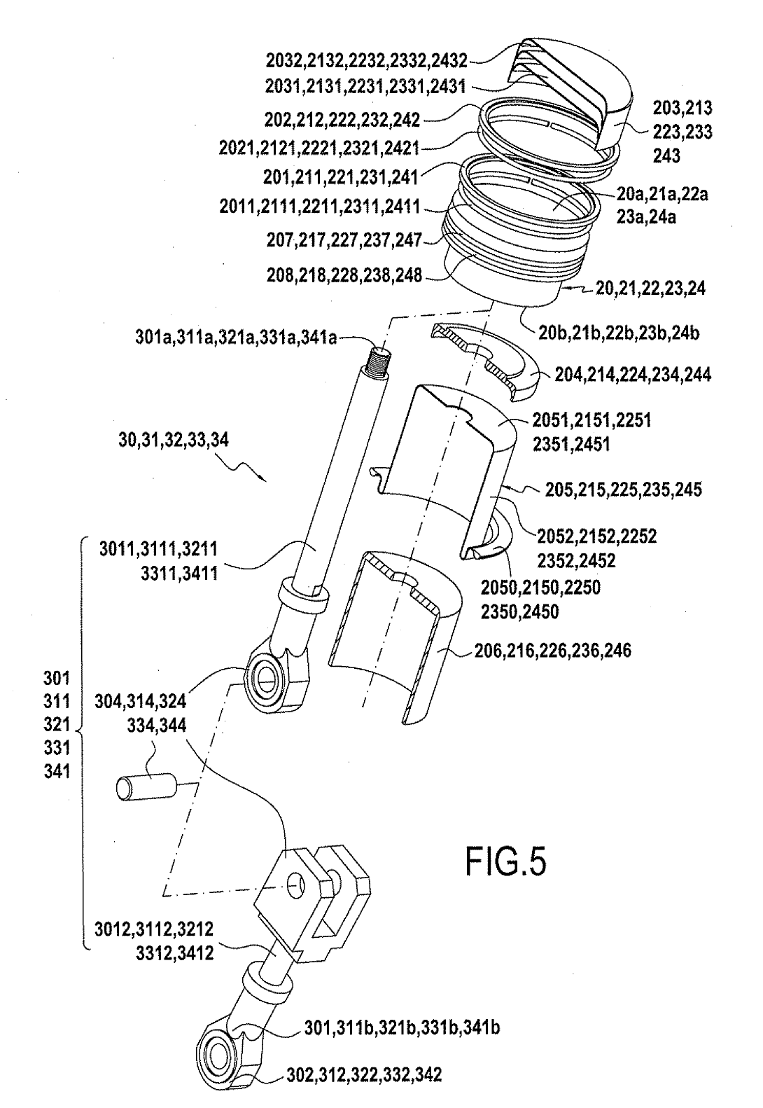

As shown in particular in FIG. 5, the ends 20b to 24b opposite from the free ends 20a to 24a of each piston 20 to 24 are connected to respective connecting rods 30 to 34. Each connecting rod 30 to 34 comprises a body 301, 311, 321, 331, 341 made up of two portions 3011/3012, 3111/3112, 3211/3212, 3311/3312, 3411/3412, the two portions of each body being connected together via a respective hinge fork 304, 314, 324, 334, 344. Each body 301, 311, 321, 331, 341 extends over a determined length between a first end 301a, 311a, 321a, 331a, 341a connected to the piston and a second end 301b, 311b, 321b, 331b, 341b extended by a respective connecting rod head 302, 312, 322, 332, 342.

Each piston 20 to 24 is provided with two annular piston rings 201/202, 211/212, 221/222, 231/232, 241/242 housed respectively in two grooves 207/208, 217/218, 227/228, 237/238, 247/248 provided in the side wall of each piston, the piston rings possibly being made in particular of Iglidur® 30 material and presenting a thickness of 3 millimeters (mm). The piston rings 201/202, 211/212, 221/222, 231/232, 241/242 serve to provide sealing between each piston 20 to 24 and the corresponding cylinder 12 to 16. The piston rings may be held against the inside wall of each cylinder 12 to 16 by means of resilient rings 2011/2021, 2111/2121, 2211/2221, 2311/2321, 2411/2421 placed in the bottoms of the grooves 207/208, 217/217, 227/228, 237/238, 247/248 formed in the side wall of each piston, the resilient rings presenting an outside diameter that is slightly greater than the inside diameter of the piston rings (FIG. 4).

Each free end 20a to 24a of the pistons 20 to 24 is covered by a respective thermal protection dome 203, 213, 223, 233, 243 having three walls serving to form two chambers 2031/2032, 2131/2132, 2231/2232, 2331/2332, 2431/2432 for providing thermal decoupling to protect the piston rings 201/202, 211/212, 221/222, 231/232, 241/242 against the high temperatures that may exist in the sealed variable-volume chambers 122, 132, 142, 152, 162.

A diaphragm type deformable gasket 205, 215, 225, 235, 245 is also mounted between each piston 20 to 24 and the corresponding cylinder 12 to 16. More precisely, the top portion 2051, 2151, 2251, 2351, 2451 of each sealing gasket 205, 215, 225, 235, 245 is held between two jaws 204/206, 214/216, 224/226, 234/236, 244/246 fastened against each end 20b to 24b of the pistons 20 to 24 when clamping the first end 301a, 311a, 321a, 331a, 341a of each connecting rod 30 to 34 to the end 20b to 24b of each piston 20 to 24 (FIG. 4), while a bottom lip 2050, 2150, 2250, 2350, 2450 of each sealing gasket 205, 215, 225, 235, 245 is held between the two flanges 123a/124a, 133a/134a, 134a/144a, 153a/154a, 163a/164a of the portions 123/124, 133/134, 143/144, 153/154, 163/164 of each cylinder 12 to 16 (FIG. 4). The side wall 2052, 2122, 2252, 2352, 2452 of each sealing gasket 205, 215, 225, 235, 245 deforms depending on the position of each piston 20 to 24 (FIG. 4) in order to prevent any fluid present in the variable-volume chambers 122, 132, 142, 152, 162 leaking to the connecting rod and crank mechanism portions of the engine during the movements of the pistons.

The diaphragm type deformable sealing gasket 205, 215, 225, 235, 245 may in particular be a gasket made of Rulon® material such as the gasket sold under the reference BFA 80/70-80 50 MRB by the supplier Freundenberg Simrit GmbH & Co. KG. In a variant embodiment, the volume defined between the diaphragm type deformable sealing gasket 205, 215, 225, 235, 245 and the inside wall of the corresponding cylinder 12 to 16 may be filled with oil and connected to a circulation pump (not shown) for lubricating and cooling the pistons 20 to 24.

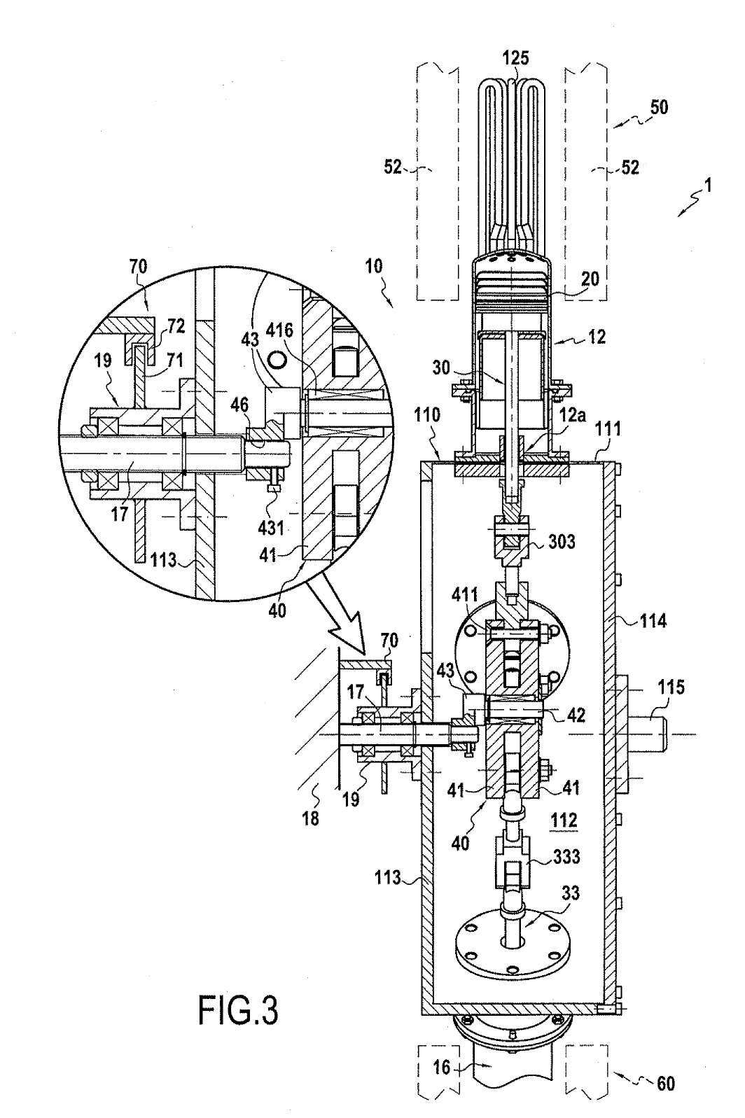

Each connecting rod head 302, 312, 322, 332, 342 is connected to a respective wrist axle 411 to 415 of a crank mechanism 40 (FIGS. 1 to 3). In the engine of the invention, the crank mechanism does not rotate. It is the entire engine block that rotates. For this purpose, the crank mechanism 40 comprises a two-level turntable 41 disposed on either side of the crank mechanism heads and movable in rotation about a crank axle 42 by means of a bearing 416 arranged between the turntable 41 and the crank axle 42 (FIG. 3). The crank axle 42 is secured to a stub axle 17 about which the engine block 10 is designed to rotate. The crank axle 42, and consequently the turntable 41 of the crank mechanism 40 is eccentric relative to the stub axle 17.

A rigid connection between the crank axle 42 and the stub axle 17 is provided by a crank lever 43 that may be secured to the stub axle 17 by means of a screw 431, for example. The stub axle 17 is fastened to a support structure 18 of the engine. Depending on the intended use, the support structure may correspond to a structure of a vehicle, of a stationary installation (building, ground, etc.), etc.

In the embodiment described herein, the piston 20 of the cylinder 12 is connected to the crank mechanism 40 by a so-called “master” connecting rod 30 that initially drives the other connecting rods 31 to 34 that constitute “secondary” connecting rods.

As explained below, the engine block 10 is driven in rotation about the axle 17. For this purpose, the engine block 10 is supported by the stub axle 17 via a bearing 19 mounted on the bottom 113 of the casing 110 through which the stub axle 17 passes. The bearing 19 may be adapted to prevent rotation in the counterclockwise or the clockwise direction in order to ensure that the engine block 10 rotates in the clockwise or the counterclockwise direction.

The casing 10 also includes a cover 114 having a shaft 115 mounted thereon to take off the rotary motion generated by the engine to be recovered.

In accordance with the invention, each variable-volume sealed chamber 122, 132, 142, 152, 162 respectively of the cylinders 12 to 16 is filled with a fluid that expands when its temperature is raised, i.e. a fluid having a high coefficient of thermal expansion. Such a fluid may be selected in particular from the following fluids: Freon, air, hydrogen, helium.

Each piston 20 to 24 includes a filler valve and a bleed valve in the vicinity of its cylinder head (not shown) in order to enable the initial fluid pressure in each variable-volume chamber to be adjusted and in order to enable the chambers to be emptied, where appropriate.

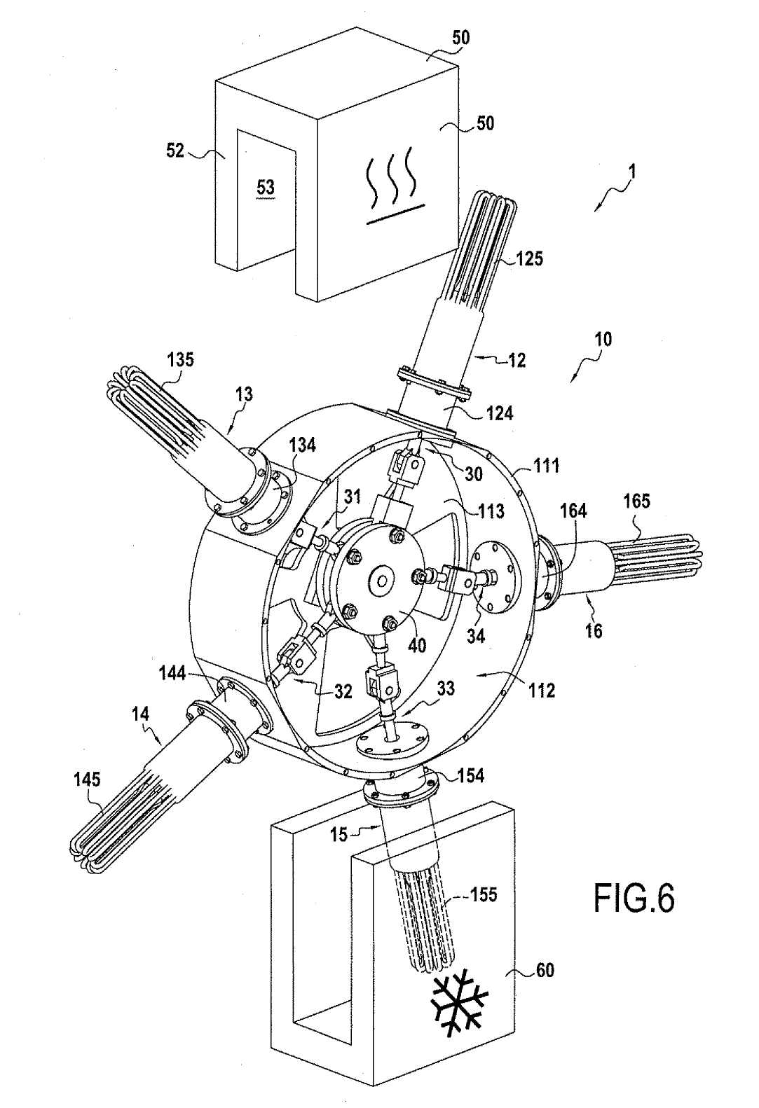

As shown in FIG. 6, the rotary engine 1 also includes a heat source constituted by heater means for locally raising the temperature of the fluid present in the variable-volume chambers 122 to 162 and for driving the engine block 10. In the embodiment described herein, the heater means are formed by a stationary enclosure 50 that is mounted, by way of example, on the support structure 18 and that comprises two panels 51 and 52 placed facing each other. On its surface facing the other panel, each of the panels 51 and 52 has radiating elements (not shown in FIG. 6), such as resistive or infrared type heater elements, suitable for creating a high temperature zone 53 inside the enclosure 50. The outer walls of the enclosure 50, and in particular those of the panels 51 and 52 are thermally insulated in order to reduce losses of heat from the enclosure. In order to encourage heat exchange between the high temperature zone and the variable-volume sealed chambers, the cylinders 12 to 16, and more particularly the tubes 125, 135, 145, 155, 165 are made of a material that is a good conductor of heat and that presents low thermal inertia, such as aluminum. The wall thickness of the tubes is likewise selected so as to be relatively fine in order to enable good exchange of heat between the inside and the outside of the tubes.

In a variant embodiment, the wall of the cylinder, and more particularly the walls of the tubes, may act as susceptors and may be heated rapidly under the effect of induced current on being subjected to a magnetic field. For this purpose, the wall of each cylinder, or at least the walls of the tubes should be made of a conductive material that is suitable for heating rapidly under the effect of induced current. Induction may be provided by a coil arranged around each plurality of cylinder tubes. Under such circumstances, the heater means are mounted in full on each cylinder and they are controlled by a control device that controls the generation of the magnetic field by each coil, e.g. as a function of the position of each cylinder as it rotates, as mentioned above. Alternatively, the induction coil may be arranged separately from the engine block in a fixed position like the above-described enclosure 50. Under such circumstances, one or more plane induction coils are used that continuously generate a magnetic field through which the cylinders pass in succession during rotation of the engine block.

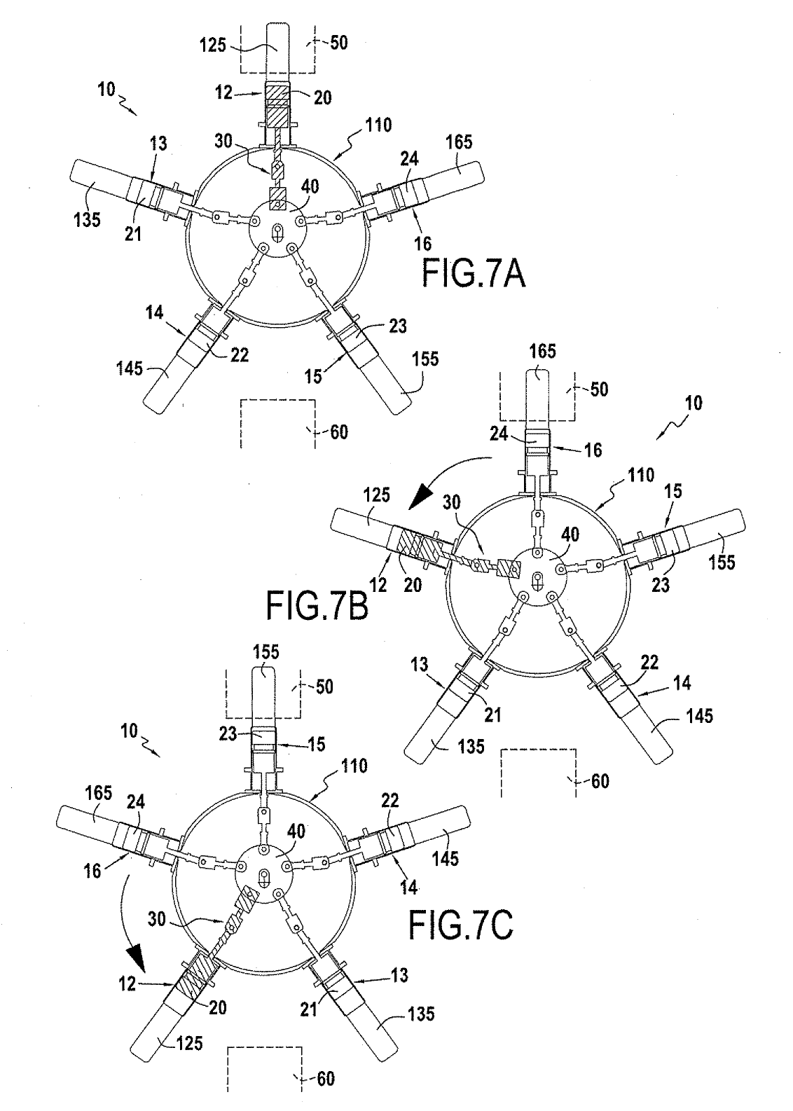

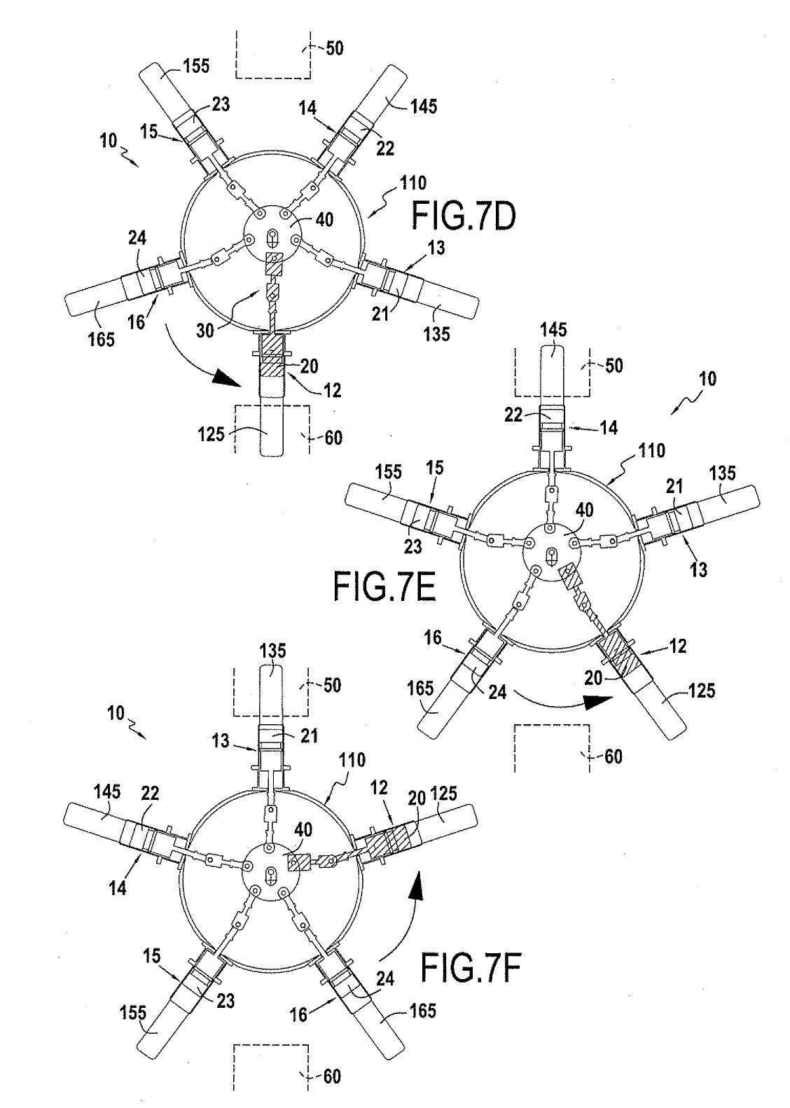

With reference to FIGS. 7A to 7F, there follows a description of the operation of the above-described engine 1.

Initially, the cylinder 12 having its piston 20 connected to the master connecting rod 30 is positioned in the enclosure 50 so as to receive heat (FIG. 7A). The fluid present in the chamber 122, and more particularly in the tubes 125, then increases in temperature and begins to expand. The expansion of the fluid gives rise to an increase in the pressure inside the chamber 122, thereby pushing back the piston 20. The movement of the piston is transformed into rotation by the connecting rod 30 connecting the piston 20 to the turntable 41 of the crank mechanism 40. In response to the force exerted by the connecting rod 30, the turntable 41 then turns about the crank axle 42, thereby driving all the other connecting rods 31 to 34 that are connected to the turntable 41. In the engine of the invention, since the crank mechanism 40 is stationary, the effect of the connecting rod rotating is to drive the entire engine block 10 in rotation about the axle 17, in the counterclockwise direction as represented by the arrow in FIG. 7A. Under such circumstances, the bearing 19 (FIG. 3) is locked in the clockwise direction in order to constrain the engine block to rotate in the counterclockwise direction.

Putting the engine block 10 into rotation in this way causes the following cylinder, here the cylinder 16, to penetrate into the enclosure 50, as shown in FIG. 7B. The temperature of the fluid present in the chamber 162 of the cylinder 16, and more particularly in the tubes 126, then increases in turn. The fluid expands in the chamber 162 and pushes back the piston 24 which, acting via the connecting rod 34, transmits its mechanical energy to the turntable 41, thereby imparting rotary drive to the engine block 10.

The following cylinders, i.e. the cylinders 15, 14, and 13 pass in succession through the enclosure 50, as shown in FIGS. 7C, 7E, and 7F. Each time a cylinder passes through the enclosure 50, mechanical energy is generated serving to drive rotation of the engine block 10 about its axle 17. The rotary movement of the engine block 10 may be recovered from the shafts 114 secured to the cover 113.

As shown in FIGS. 7A to 7D, when a cylinder, e.g. the cylinder 12, leaves the enclosure 50, the volume of its chamber, here the chamber 122, increases until the cylinder is in a position diametrically opposite to the position it was occupying when it was in position in the enclosure 50 (FIG. 7A). In this position, the volume of the chamber 122 is at a maximum and the piston is at the end of its stroke. Thereafter, when the cylinder continues to rotate over the other half of a revolution in order to penetrate once more into the enclosure 50, the volume of the chamber 122 decreases progressively since the connecting rod 30 pushes the piston 20 towards the cylinder head 121 of the cylinder 12. When the cylinder 12 is once more in position in the center of the enclosure 50 (FIG. 7A), the volume of the chamber 122 is at a minimum. The fluid present in the chamber 122 presents little or no opposition to the return of the piston 20 into the chamber 122. During the second half of the rotation of the cylinder 12 as shown in FIGS. 7D to 7F, the fluid present in the chamber 122 has lost the majority of the heat it received while passing through the enclosure 50 and it no longer expands. On the contrary, the fluid begins to cool and consequently to contract.

In order to accelerate cooling of the fluid in the cylinder chambers after they have passed through the heater enclosure 50, the engine of the invention may also include a cooling device 60 arranged opposite from the enclosure 50, as shown in FIG. 6. The cooling device may correspond to a bath of cooling liquid through which the cylinders of the engine pass in succession during rotation, or to a refrigerated enclosure that defines a low-temperature zone. In order to increase the efficiency of the bath of cooling liquid or of the refrigerated enclosure, the cooling device may also be fitted with fans so as to establish a forced flow of air around the tubes of each of the cylinders.

When the cylinders are fitted with their own heater means, the cooling device is placed in a position opposite to the position in which the heater means are activated during rotation of the engine block.

The rotary expansion engine of the invention pollutes very little since it does not exhaust any combustion gas. It also presents relatively low energy consumption, where its consumption corresponds solely to the energy needed for powering the cylinder heater means, and optionally the cooling enclosure when it makes use of active cooling means.

In a variant embodiment, the engine block 10 is connected to a brake device that acts in alternation to block and to release the rotary movement of the engine as a whole as a function of the fluid pressure in each cylinder when each cylinder is exposed to the source of heat. More precisely, as shown in FIG. 3, the engine of the invention may be provided with a brake device 70 comprising a disk 71 secured to the bearing 19, and a brake member 72 secured to a base that is stationary relative to the engine block such as the engine support structure 18. The brake member 72 is suitable for stopping the rotation of the disk 71, and consequently for stopping the rotation of the engine block 10 as a whole as a function of the angular position of each cylinder. The disk 71 may be stopped by the brake member 72 in particular by means of a jaw or by calipers, or indeed by means for applying an electromagnetic force. The brake member also includes means, e.g. such as an electronic control circuit, serving to block rotation of the engine block 10 when one of its cylinders enters the heater enclosure 50 and to release the disk 71, and consequentially to release rotation of the engine block, after a predetermined length of time or when the fluid in the cylinder reaches a threshold pressure value. Under such circumstances, the cylinders are fitted with pressure sensors (not shown) serving to measure the pressure in the variable-volume chamber of each cylinder and to transmit the measured pressure to the electronic circuit for controlling the brake member. The brake member also includes means (not shown) for determining or measuring the angular position of each cylinder in order to block each cylinder in the heater enclosure. As a result, the engine of the invention may present operation that is discontinuous with stop/start stages that are defined as a function of the angle present between two consecutive cylinders so as to make it possible, in particular, to achieve optimum heating of the fluid present in the variable-volume chambers by increasing the length of time each cylinder is exposed to the source of heat.

1. A rotary engine comprising an engine block that is movable in rotation about an axle, said engine block including at least one blind cylinder mounted on a casing, said blind cylinder being closed by a movable piston defining a sealed chamber of variable volume inside the cylinder, each piston being connected to a crank mechanism secured to stub axle of the engine block, wherein the variable-volume sealed chamber of each piston contains a fluid suitable for expanding under the effect of a rise in temperature, the engine further including heater means for raising the temperature of the fluid present in said chamber.

2. An engine according to claim 1, wherein the heater means comprise a stationary heat source arranged on the path of each cylinder in such a manner as to heat the fluid present in each of the cylinders, in succession.

3. An engine according to claim 2, wherein the heat source comprises radiant heater elements.

4. An engine according to claim 1, wherein the heater means comprise a susceptor formed by of each cylinder of the variable-volume sealed chamber, an induction unit being arranged in a fixed position on the path of each cylinder.

5. An engine according to claim 1, wherein each cylinder includes a plurality of tubes extending from the cylinder head of each cylinder, said tubes in each plurality of tubes being in communication with the variable-volume sealed chamber containing the fluid that is suitable for expanding under the effect of a temperature rise.

6. An engine according to claim 5, wherein the tubes of each plurality of tubes are spaced apart from one another by a determined distance so as to encourage a large flow of air around the tubes.

7. An engine according to claim 1, wherein each cylinder further includes a diaphragm type deformable sealing gasket comprising a body of flexible material extending between a bottom portion and a top portion, said top portion of the gasket being held against the bottom end of the piston, while the bottom portion of the gasket is held between two flanges of each cylinder.

8. An engine according to claim 1, further including a brake device for blocking rotation of the engine block as a function of the position of each cylinder.

9. An engine according to claim 8, wherein each cylinder includes a pressure sensor for measuring the pressure of the fluid present in the variable-volume chamber, the pressure measured by said sensor being transmitted to a circuit for controlling the brake device.

10. An engine according to claim 1, wherein the fluid is selected from at least one of the following fluids having a high coefficient of thermal expansion: Freon, air, helium, hydrogen.

11. An engine according to claim 1, further including a stationary cooling device arranged along a path of each cylinder.
